(19) United States
(12) Patent Application Publication
(10) Pub. No.: US 2009/0119135 A1
(43) Pub. Date: May 7, 2009

(54) METHOD AND APPARATUS FOR REAL TIME GENERATION OF CHARTER FLIGHTS

(76) Inventors: David Lawrence Schoeman, Centennial, CO (US); Richard William Ellerbrock, Highlands Ranch, CO (US)

Correspondence Address: DUKE W. YEE, YEE & ASSOCIATES, P.C., P.O. BOX 802333, DALLAS, TX, 75380, US

(21) Appl. No.: 11/934,160

(22) Filed: Nov. 2, 2007

(51) Int. Cl. G06Q 10/00; G06F 17/40; G06Q 30/00

(52) U.S. Cl. 705/5

(57) ABSTRACT

A computer implemented method, apparatus, and computer program product for managing charter flights. Current status is monitored for a plurality of aircraft including any aircraft currently in-flight. In response to receiving a request from a requester for service from a departure location to an arrival location, a set of flights from the departure location to the arrival location is identified using the current status of the plurality of aircraft to form a set of potential flight choices. A cost analysis is performed on the set of potential flight choices to form a set cost results. A portion of the set of potential flight choices is selected based on the set of cost results to form a set of planned flights. The set of planned flights is presented to the requester.

### BACKGROUND INFORMATION

1. Field

The present disclosure relates generally to an improved data processing system and a particular method and apparatus for arranging aircraft transportation. Still more particularly, the present disclosure relates to a computer implemented, apparatus, and computer program product for generating charter flights.

2. Background

Commercial carriers typically offer flights in the form of scheduled flights. A scheduled flight is a flight that is operated based on any fixed or variable published schedule. With these types of flights, departure and arrival times and dates are published, and passengers are able to buy a seat reservation for a given scheduled flight.

Another system for flying involves charter flights. With charter flights, a flight is bought specifically to meet customer demand. A charter operator fills a customer request for a flight based on customer schedules and times rather than publishing their own schedules and times. With these types of flights, the customer may often be late and the flight is held, or a customer may change plans enroute with those flight changes being accommodated by the charter operator.

With charter flights, while a flight plan is filed, the customer is essentially renting the plane and crew for a given time and paying by the hour of flight time plus other costs or fees. These other costs or fees may include, for example, a deadhead return flight in which no passengers are present, or idle time at the airport when the plane and crew waits for a return trip by the customer.

Charter flights present increased flexibility to customers as compared to using traditional commercial flights. Charter flights, however, are usually more costly than commercial flights on a per seat basis because customers may be required to charter the entire plane. With the introduction and use of very light jets, lower cost options are now present as compared to traditional charter flights.

Even with the introduction of very light jets, charter operators still face challenges in maximizing seat occupancy for charter flights. Various solutions have been used to try to increase utilization of charter aircraft. For example, some charter operators provide one way pricing for charter flights. If a customer charters a flight from a first city to a second city without a return flight, the charter operators may have an open flight where the customer pays for a return flight with no passengers. This open flight is also referred to as a deadhead flight or leg.

In efforts to increase utilization of charter aircraft, some charter aircraft operators encourage ride sharing in which different customers may share an aircraft traveling from the same departure to the same destination location, or some part thereof, or sell discounted flights where a deadhead flight leg would otherwise be flown.

Therefore, it would be advantageous to have a computer implemented method, apparatus, and computer program code for solving the above described problems with respect to charter flights.

### SUMMARY

The advantageous embodiments provide a computer implemented method, apparatus, and computer program product for managing deadhead charter flight legs. In one advantageous embodiment, a computer implemented method monitors a current status for a plurality of aircraft from multiple charter operators including any aircraft currently in-flight. In response to receiving a request from a requester for service from a departure location to an arrival location (or dynamically from/to an appropriate nearby departure or arrival location), a set of flights from the departure location to the arrival location is identified using the current status of the plurality of available, or soon to be available, aircraft to form a set of potential flight choices. A cost analysis is performed on the set of potential flight choices to form a set of cost results. A portion of the set of potential flight choices is selected based on the set of cost results to form a set of planned flights. The set of planned flights is presented to the requester.

In another advantageous embodiment, an apparatus comprises a request system, a flight tracking system, a route generator, and a cost analysis system. The request system is capable of receiving flight requests, and the flight tracking system is capable of real time monitoring of the status for a plurality of aircraft. The route generator is capable of generating a set of new routes for a portion of the plurality of aircraft based on current aircraft status and a set of received flight requests to form a set of generated routes. The cost analysis system is capable of determining a cost status for each of the set of generated routes.

In yet another advantageous embodiment, a computer program product comprises a computer recordable medium and program code. The program code includes code for monitoring a current status for a plurality of aircraft including any aircraft currently in-flight. The program code also includes code, responsive to receiving a request from a requester for service from a departure location to an arrival location, for identifying a set of flights from the departure location to the arrival location using the current status of the plurality of aircraft to form a set of potential flight choices. The program code has code for performing a cost analysis on the set of potential flight choices to form a set of cost results and code for selecting a portion of the set of potential flight choices based on the set of cost results to form a set of planned flights. The program code includes code for presenting the set of planned flights to the requester.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives and advantages thereof, will best be understood by reference to the following detailed description of an advantageous embodiment of the present disclosure when read in conjunction with the accompanying drawings, wherein:

FIG. 1 is a pictorial representation of a network of data processing systems in which the advantageous embodiments of the present invention may be implemented;

FIG. 2 is a diagram of a data processing system in accordance with an advantageous embodiment;

FIG. 3 is a diagram illustrating a charter flight management environment in accordance with an advantageous embodiment;

FIG. 4 is a diagram of a charter service in accordance with an advantageous embodiment;

FIG. 5 is a diagram illustrating an operation of a charter flight management environment in accordance with an advantageous embodiment;

FIG. 6 is a diagram illustrating processing of a charter flight using a charter flight management environment in accordance with an advantageous embodiment;

FIG. 7 is an example of minor re-positioning to schedule a charter flight in accordance with an advantageous embodiment;

FIG. 8 is a diagram of a record in a flight database in accordance with an advantageous embodiment;

FIG. 9 is a diagram of a record for a user profile in accordance with an advantageous embodiment;

FIG. 10 is a record illustrating an example of information that may be entered by a user requesting a flight in accordance with an advantageous embodiment;

FIG. 11 is a diagram of a record comprising aircraft information in accordance with an advantageous embodiment;

FIG. 12 is a high level flowchart of a process for managing charter flights in accordance with an advantageous embodiment;

FIG. 13 is a flowchart of a process for requesting a flight in accordance with an advantageous embodiment;

FIG. 14 is a flowchart of a process for identifying potential flight choices to generate a set of planned flights in accordance with an advantageous embodiment; and

FIG. 15 is a flowchart of a process for scheduling a selected planned flight in accordance with an advantageous embodiment.

### DETAILED DESCRIPTION

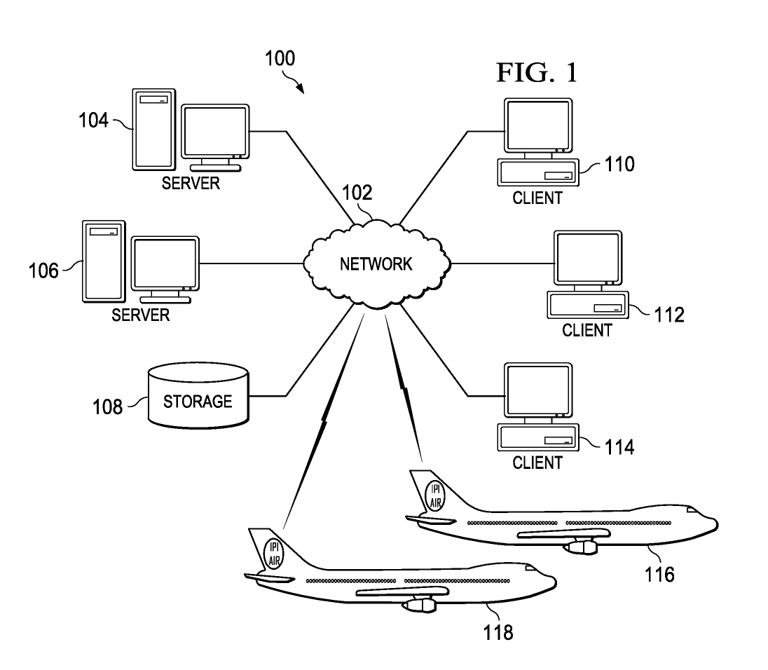

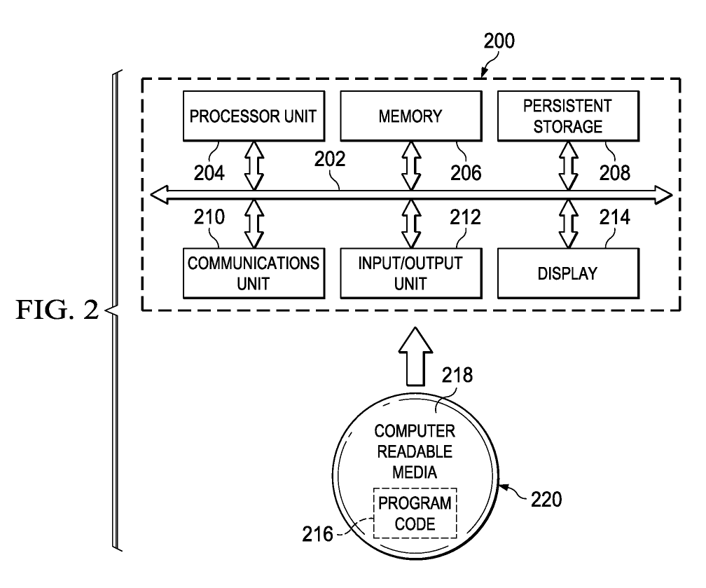

With reference now to the figures and in particular with reference to FIGS. 1-2, exemplary diagrams of data processing environments are provided in which the advantageous embodiments of the present invention may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which the advantageous embodiments of the present invention may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Aircraft 116 also is a client that may exchange information with clients 110, 112, and 114. Aircraft 116 also may exchange information with servers 104 and 106. Aircraft 116 may exchange data with different computers through a wireless communications link while in-flight or any other type of communications link while on the ground. In these examples, server 104, server 106, client 110, client 112, and client 114 may be computers

In these examples, aircraft 116 and aircraft 118 may be aircraft that belong to a set of charter operators. The different advantageous embodiments may be implemented in network data processing system 100 to provide generation of charter flights for aircraft, such as aircraft 116 and aircraft 118. In these examples, the generation of flights may be performed in a real time manner taking into account the current location of the aircrafts on the ground and in the air.

Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

Turning now to FIG. 2, a diagram of a data processing system is depicted in accordance with an advantageous embodiment. Data processing system 200 is an example of a data processing system that may be used to implement servers and clients, such as server 104 and client 110. Further, data processing system 200 is an example of a data processing system that may be found in aircraft 116 in FIG. 1.

In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as, program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media 218 is also referred to as computer recordable storage media.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The different advantageous embodiments recognize that existing flight generation systems match a request to propose a flight leg or an existing reservation. This type of process has an incremental value in boosting utilization rates of charter aircraft. The different advantageous embodiments also recognize that an opportunity exists to increase utilization rates even higher by changing the entire flow or interaction between customers who desire service and charter operators who provide the service.

Using the different advantageous embodiments to generate charter flights on a dynamic basis, charter operators may make adjustments to scheduled flights and perform simple add on of passengers for ride shares. Additionally, new flight legs may be created to best meet the needs of customers requiring service.

The different advantageous embodiments provide a computer implemented method, apparatus, and computer program product for managing charter flights. A current status for aircraft is monitored including those currently in flight. In response to receiving a request from a requester for service from a departure location to an arrival location, a set of aircraft potentially available to fly a route from the departure location to the arrival location are identified to form a set of potential flight choices.

A cost analysis of the set of potential flight choices are performed to form a set of cost results. A portion of the set of potential flight choices are selected based on the set of results to form a set of planned flights. These planned flights are presented to the requester. In this manner, the requester may select a particular flight and schedule the planned flight to become a charter flight.

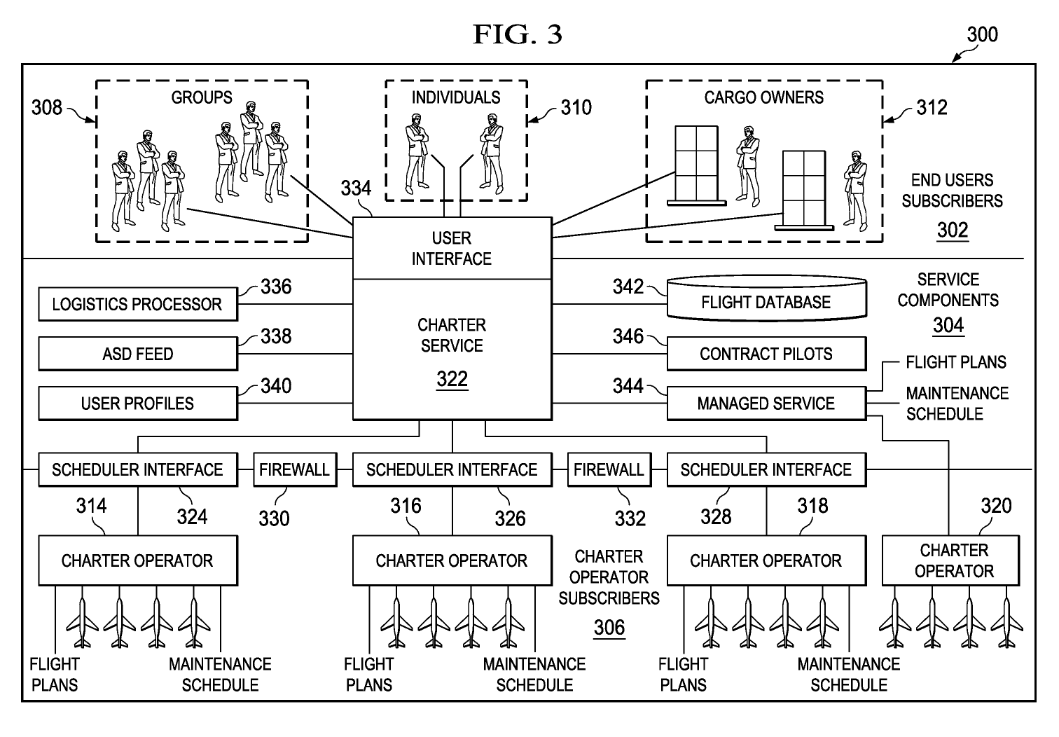

With reference now to FIG. 3, a diagram illustrating a charter flight management environment is depicted in accordance with an advantageous embodiment. In this example, charter flight management environment 300 is an example of an environment that may be implemented using network data processing system 100 in FIG. 1. As illustrated, charter flight management environment 300 includes end user subscribers 302, service components 304 and charter operator subscribers 306.

End user subscribers 302 include groups 308, individuals 310, and cargo owners 312. Individuals 310 include single passengers who desire charter service. Groups 308 are groups of people who require charter service. Groups 308 typically charter a portion or an entire aircraft. Cargo owners 312 are organizations or people who require charter services to transport cargo.

Charter operator subscribers 306 include charter operator 314, charter operator 316, charter operator 318, and charter operator 320. In these examples, charter operators 314, 316, and 318 are standard charter operators. These types of charter operators subscribe to services providing my charter flight management environment 300 to increase revenue through additional utilization of aircraft and/or pilot assets. Charter operator 320 in this example is a managed charter operator subscriber. This type of charter operator is similar to a standard charter operator subscriber. These types of charter operator, however, also utilize or subscribe to additional services, such as flight planning and maintenance services.

In these examples, charter flight management environment 300 provides an ability to identify and offer potential flight choices from multiple charter operators in charter operator subscribers 306. This type of environment provides more choices to potential charter flight passengers than is presently available.

Service components 304 include charter service components 322, scheduler interface 324, scheduler interface 326, scheduler interface 328, firewall 330, firewall 332, user interface 334, logistics processor 336, aircraft situation display (ASD) feed 338, user profiles 340, database 342, managed service 344, and contract pilots 346. Charter service 322 and logistics processor 336 are software components that may be implemented in a data processing system, such as data processing system 200 in FIG. 2.

Charter service 322 provides optimized match up between customers and end user subscribers 302 and available charter aircraft. Charter service 322 receives requests from customers in end user subscribers 302 through user interface 334. Available options are presented by charter service 322 through user interface 334 to customers. Desired options may be selected and confirmation of charter flights may be performed using charter service 322. The different software components illustrated in service components 304 may be located on a data processing system, such as data processing system 200 in FIG. 2. The different components may be implemented on the same or different data processing systems depending on the particular implementation.

Logistics processor 336 acts as a route generator and identifies potential flight choices based on various parameters. These parameters include, for example, user preferences, selections, and schedule availabilities of customers or users at end users 302. The factors also include, for example, schedule availabilities of charter operators in charter operator subscribers 306. Logistics processor 336 may perform a cost analysis to identify charter operators within charter operator subscribers 306 to provide potential flight choices. The cost analysis may include, for example, comparing the cost of a flight to the benefit of the flight.

Logistics processor 336 also acts as a cost analysis system capable of determining a cost and benefit for different flights that this component identifies. This component generates a cost analysis that indicates that the cost is too high versus the benefit for a particular charter operator, then aircraft will not be identified for a potential flight choice. The same cost analysis for another charter operator may be identified for a potential flight choice because this charter operator allows for making less profit than the other charter operator.

In these examples, logistic processor 336 generates results from cost analysis in the form of profit in these examples. Of course, in other examples other parameters may be selected in addition to or in place of profit. For example, an identification of whether a particular potential flight choice required maintenance after the flight may be considered. For example, if maintenance is required and the aircraft is out of service on certain dates, the charter operator may not wish to have that aircraft out of service even though the profit level is sufficient to meet their goals. Illustrative analysis algorithms may include, for example, identifying and adding fixed and variable cost drivers. Examples include, without limitation, the hourly operational cost, flight crew cost, landing costs, dispatch cost, and minimum desired operation profit. Other factors also include, for example, discounting agreements in place for situations in which multiple passengers and/or ride sharing are present. The costs and desired profit may be compared to a customer did price for service or may be used to generate an proposed price for the flight. Also, multiple factors may be computed by for evaluation with fixed operational costs and maintenance costs to determine economic viability of offering a flight leg to a customer.

Scheduler interface 324 provides an interface to charter operator 314; scheduler interface 326 provides an interface to charter operator 316; and scheduler interface 328 provides an interface to charter operator 318. These scheduler interfaces are software components that provide interfaces to schedule information from charter operators into charter service 322.

This information is used to develop an aggregate schedule from which a user or customer may select flights and receive confirmations. The schedule information may include, for example, available seats in charter flights having ride share options in which additional riders may pay for seats on a flight that has already been chartered, which could result in lower costs for each customer, yet yield higher profits for the charter operator. Additionally, these schedule interfaces also provide an interface to receive confirmation from the charter operators when users in end user subscribers 302 select a planned flight for scheduling. A planned flight is a potential flight that has been identified that may be offered to a user for scheduling as a charter flight. Firewall 330 and firewall 332 may be software and/or hardware components that insure data from one charter operator is separated from other charter operators.

Aircraft situation display (ASD) feed 338 is a data input that provides near real time information about the current location and movement of aircraft belonging to charter operator subscribers 306. In these examples, charter service 322 includes a flight tracking system or process capable of real time monitoring of a status for a plurality of aircraft for multiple charter operators using aircraft situation display (ASD) feed 338.

In some cases, the information in aircraft situation display (ASD) feed 338 may only be for some of the aircraft for a particular operator. Aircraft situation display (ASD) feed 338 provides information that may be used to track aircraft in a real time manner. Data within aircraft situation display (ASD) feed 338 includes, for example, location, altitude, air speed, destination, estimated time of arrival, or other suitable identifier of an air carrier of an aircraft. These aircraft situation display feeds may be obtained from the Federal Aviation Agency (FAA) for these types of operations. Also, as another example, these types of feeds may be available from various European counties.

User profiles 340 contain information about users in end user subscribers 302. Charter service 322 includes a passenger and user profile system or process to create and manage user profiles 340. These profiles are used by charter service 322 to create optimized matches in flights, aircraft, and other services. User profiles 340 are used to refine the potential flight choices identified by logistics processor 336. Logistics processor 336 may select a portion of the identified potential flight choices based on user profiles 340. In other embodiments, logistics processor 336 may use user profiles 340 to provide an order for identified potential flight choices. For example, if a user has a particular preference of an aircraft type end user profiles 340, aircraft of that aircraft type may be placed first in identified potential flight choices for the user. Of course, many other types of user preferences may be stored end user profiles 340, such as, for example, aircraft size, willingness to ride share, and willingness to depart or arrive at another airport within some selected distance from the requested airport.

Charter service 322 stores flights, such as charter flights and open flights in flight database 342. Flight database 342 contains information about charter flights needed by logistics processor 336 to identify potential flight choices. Information about charter flights and open flights may be received from charter operator subscribers 306 through scheduler interfaces 324, 326, and 328. As changes are made, charter operator subscribers 306 send this information to charter service 322 for storage in flight database 342.

With respect to the type of flights that may be scheduled as charter flights by charter service 322, agreements or preferences by charter operators within charter operator subscribers 306 may identify what types of flights may be scheduled by charter service 322.

As a result, information in flight database 342 contains flights from multiple charter operators and may be used to generate potential flight choices for aircraft currently within flight database 342. This database constantly changes as charter operator subscribers 306 sends changes and end user subscribers 302 makes requests. Flight database 342 also may store information about aircraft and their status

Managed service 344 is a third party service that manages flight operation elements or a charter operator. These services include providing flight plans and maintenance schedules. In this example, managed service 344 provides services to charter operator 320 in charter operator subscribers 306.

In these examples, contract pilots 346 is a database identifying contract pilots that may be available to fly aircraft for charter operator subscribers 306. This information includes, for example, identification of pilots, qualifications, and availabilities. In some situations, a contract pilot or other crew may be needed for a charter flight because the current crew may be unable to fly an identified potential flight choice. An example of when this type of situation may occur is when pilots are allowed to fly only some selected number of hours prior to having a mandatory rest time. An identified potential flight choice for an aircraft with the assigned crew may be unavailable if the current pilot is required to fly that potential flight choice. As a result, a contract pilot may be identified from contract pilots 346 to make this flight choice possible.

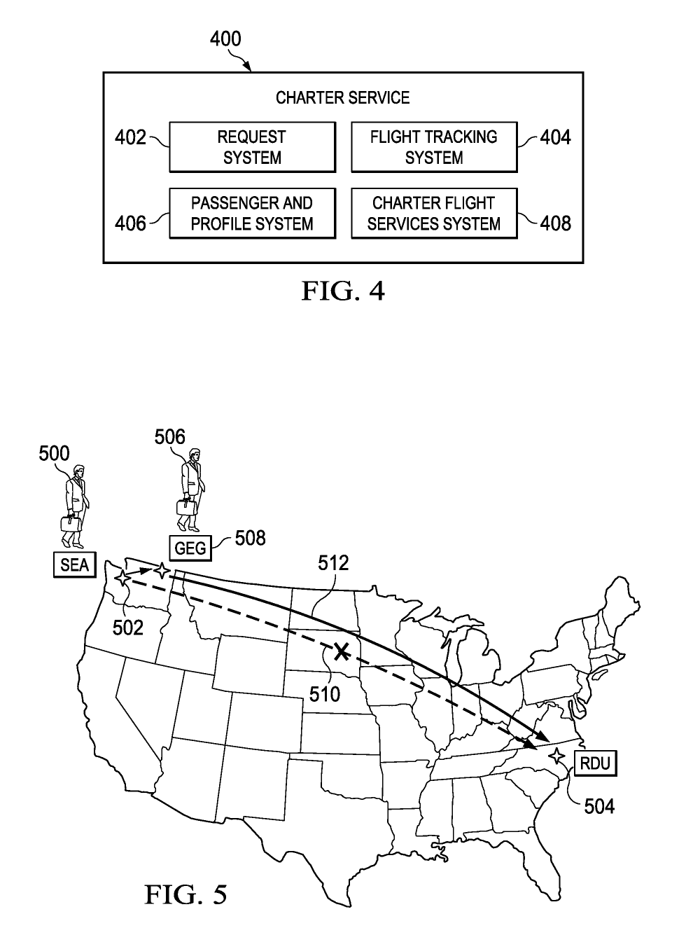

With reference now to FIG. 4, a diagram of a charter service is depicted in accordance with an advantageous embodiment. In this example, charter service 400 is a more detailed example of charter service 322 in FIG. 3. In this example, charter service 400 includes request system 402, flight tracking system 404, passenger and profile system 406, and charter flight services system 408.

Request system 402 is capable of receiving flight requests. In these examples, a request may be received through a user interface, such as user interface 334 in FIG. 3. Flight tracking system 404 is capable of real time monitoring of a status for aircraft for multiple charter operators. This tracking and monitoring may be performed using aircraft situation display feeds.

Passenger and profile system 406 is capable of storing user profile preferences. This type of information may be used by logistics processor 336 in FIG. 3 in generating new routes for aircraft present as planned flights for one or more users. Charter flight services system 408 is capable of receiving information about aircraft from multiple charter operators.

This information may include, for example, current charter flights, planned flights, and other information that may be useful for generating planned flights to increase utilization of aircraft for charter operators. This information may be stored and associated with the different charter operators for use in identifying a planned flight.

The components illustrated in FIG. 4 are presented as functional components and not meant to impose architectural limitations on the manner in which charter service 400 may be implemented. In different advantageous embodiments, the different functions and processes described for these components may be combined into fewer components or additional components may be generated.

Turning now to FIG. 5, a diagram illustrating an operation of a charter flight management environment is depicted in accordance with an advantageous embodiment. In this example, a charter flight has been scheduled to carry passenger 500 from Seattle (SEA) 502 to Raleigh (RDU) 504. Prior to departure, a request comes from passenger 506 located in Spokane (GEG) 508 who also desires transportation to Raleigh (RDU) 504. The charter service provider recognizes the potential benefit of a lower per seat charge with two passengers on the flight rather then a single passenger.

In this example, passenger 500 has agreed to allow the aircraft to make a stop at Spokane (GEG) 508 to pick up passenger 506 and then continue to Raleigh (RDU) 504. As a result, the original planned route for the charter flight along route 510 is canceled and a new route 512 occurs. With this type of situation, passenger 500 has a first right of refusal for the suggested change. However, by accepting the change, the cost to passenger 500 may be reduced.

In this example, passenger 500 and passenger 506 both have a reduced cost in their flights as compared to taking charter flights individually to their destinations. As a further benefit, the charter operator is able to increase revenues by increasing the number of seats occupied in its aircraft. The altering of the flight schedule to use route 512 instead of route 510 is accomplished in these examples using charter flight management environment 300 in FIG. 3.

In this example, passenger 500 may log on to charter service 322 in FIG. 3 through user interface 334 in FIG. 3 to request potential flight choices from Seattle (SEA) 502 to Raleigh (RDU) 504. If passenger 500 is a first time user of charter flight management environment 300 in FIG. 3, passenger 500 establishes a user profile. This user profile may include, for example, name, address, payment preferences, and default preferences for flights. This type of information is used to establish a user profile, such as end user profiles 340 of FIG. 3 for passenger 506.

Thereafter, passenger 506 enters information about the desired flight. This information may include, for example, departure airport, departure time, or a window of time for departure, arrival airport, desired arrival time or window of time, or any other parameters needed for the flight.

Further, as part of making the request through user interface 334 in FIG. 3, passenger 500 may override some or all of the default preferences set up in the user profile. For example, in the case of an emergency trip, passenger 506 may be less picky about the type of aircraft, catering preferences, and ride sharing.

This request is received by charter service 322 in FIG. 3, which may identify charter flights that may have open seats for ride sharing along with flights that may already be in route. In addition, opportunities for repositioning aircraft may be considered in identifying potential flight choices for passenger 500. A re-positioning of an aircraft involves moving an aircraft to an unplanned location to take advantage of a fare. This type of re-positioning may occur if the fare for passenger 500 has a benefit that outweighs the cost of moving the aircraft. This type of potential flight identification is performed using logistics processor 336 in FIG. 3. Buffers or ranges are considered in identifying potential flight choices by logistics processor 336 in FIG. 3.

For example, a preset maximum number of deviations to request pick up and drop off times, location airport distance from departure and arrival locations selected by passenger 500 are examples of parameters that may be considered by logistics processor 336 in generating potential flight choices for passenger 500.

The identified potential flight choices are presented to passenger 500 by charter service 322 through user interface 334 in FIG. 3. Passenger 500 may then select a potential flight choice from a set of potential flight choices presented. Passenger 500 is presented with a set of planned flights. These planned flights are non-guaranteed offerings, meaning that in the time needed to make the selection, the flight may have changed or become unavailable due to other users making commitment requests.

Further, in these examples the charter operator also makes a commitment to serve the customer with the flight. Of course in other embodiments, the charter operator may already provide charter service 322 with commitments for certain types of flights or aircraft that do not have to be confirmed. As a result, passenger 500 confirms the planned flight along route 510, this planned flight is then sent to a charter operator of the aircraft for confirmation of the availability of the selected planned flight. In this example, the selection and confirmation is made with charter operator 314 through scheduler interface 324 in FIG. 3.

When a confirmation occurs, passenger 500 receives identification through user interface 334 in FIG. 3 and may then complete scheduling of the charter flight. This scheduling may also include a payment or arrangement for payment of the flight.

Subsequently, passenger 506 may request a flight from Spokane (GEG) 508 to Raleigh (RDU) 504 in identifying potential flight choices to present to passenger 506 as planned flights. The flight with passenger 500 is then identified for potential re-positioning. Further, passenger 500 has indicated that ride sharing is acceptable.

When passenger 506 selects route 512, passenger 500 is contacted to determine whether the re-positioning is acceptable. In some embodiments, consulting passenger 500 may be unnecessary, but in most cases request for permission is obtained. Additionally, this request also may include a negotiated fee for passenger 500 to reduce the fare with a detour through Spokane (GEG) 508 using route 512 instead of route 510.

If passenger 500 agrees to the change, passenger 506 is notified of the change through user interface 334 in FIG. 3 and schedules the planned flight to become a charter flight. This scheduling may include, for example, arranging for payment for the flight. In these examples, payment by passenger 500 and 506 may be electronic payments, such as, for example, credit cards or electronic fund transfers.

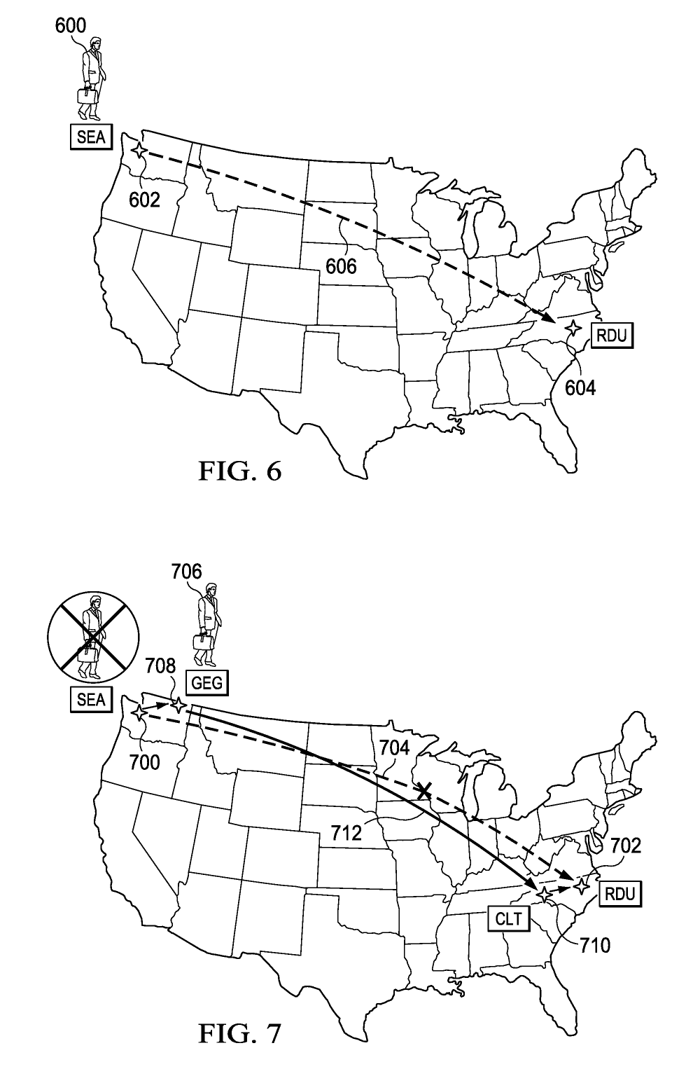

Turning now to FIG. 6, a diagram illustrating processing of a charter flight using a charter flight management environment is depicted in accordance with an advantageous embodiment. In this example, passenger 600 is a subscriber in end user subscribers 302 for charter flight management environment 300 in FIG. 3.

Passenger 600 desires to travel from Seattle (SEA) 602 to Raleigh (RDU) 604. In response to this request, charter service 322 invokes logistics processor 336 to identify potential flight choices that may be presented as planned flights to passenger 600. Passenger 600 is provided with a prioritized list of choices from different charter operators in charter operator subscribers 306 based on results received from logistics processor 336 in FIG. 3. Based on the user request and preferences. The planned flights may include information, such as departure airport, departure time, type of aircraft, services available on the flight, price, and other suitable information.

Passenger 600 then selects a particular flight, such as a flight from Seattle (SEA) 602 to Raleigh (RDU) 604 using route 606. In this example, route 606 is a deadhead leg or open flight in which the aircraft is returning from a prior charter flight to its base location without any passengers.

This request is then sent to a charter operator, such as charter operator 314 in FIG. 3 for confirmation. When charter operator 314 in FIG. 3 returns a confirmation of availability to charter service 322 in FIG. 3, charter service 322 in FIG. 3 then notifies passenger 600 and schedules payment. Alternatively, a payment may be scheduled directly between user 602 and charter operator 314 in FIG. 3. Charter operator 314 in FIG. 3 then provides itinerary and other information to user 600.

With reference now to FIG. 7, an example of minor re-positioning to schedule a charter flight is depicted in accordance with an advantageous embodiment. In this example, charter operator 314 in FIG. 3 has planned an open flight from Seattle (SEA) 700 to Raleigh (RDU) 702 along route 704. This information is stored in flight database 342 in FIG. 3.

In this example, passenger 706 has made a request to charter service 322 for a charter flight from Spokane (GEG) 708 to Charlotte (CLT) 710 along route 712. Logistics processor 336 in FIG. 3 identifies the planned open flight along route 704. In performing cost analysis, logistics processor 336 determines that the benefit of passenger 706 paying a fare and then re-positioning the aircraft from Seattle (SEA) 700 to Spokane (GEG) 708 along with a further repositioning from Charlotte (CLT) 710 to Raleigh (RDU) 702 outweighs the costs of using the planned open flight route 704. As a result, a planned flight along route 712 is presented to user 706.

In this example, user 706 selects this particular route, resulting in a request for confirmation being sent to charter operator 314 in FIG. 3. Charter operator 314 in FIG. 3 confirms the request. Charter operator 314 in FIG. 3 receives or arranges for payment from user 706 and schedules the planned flight to form a charter flight.

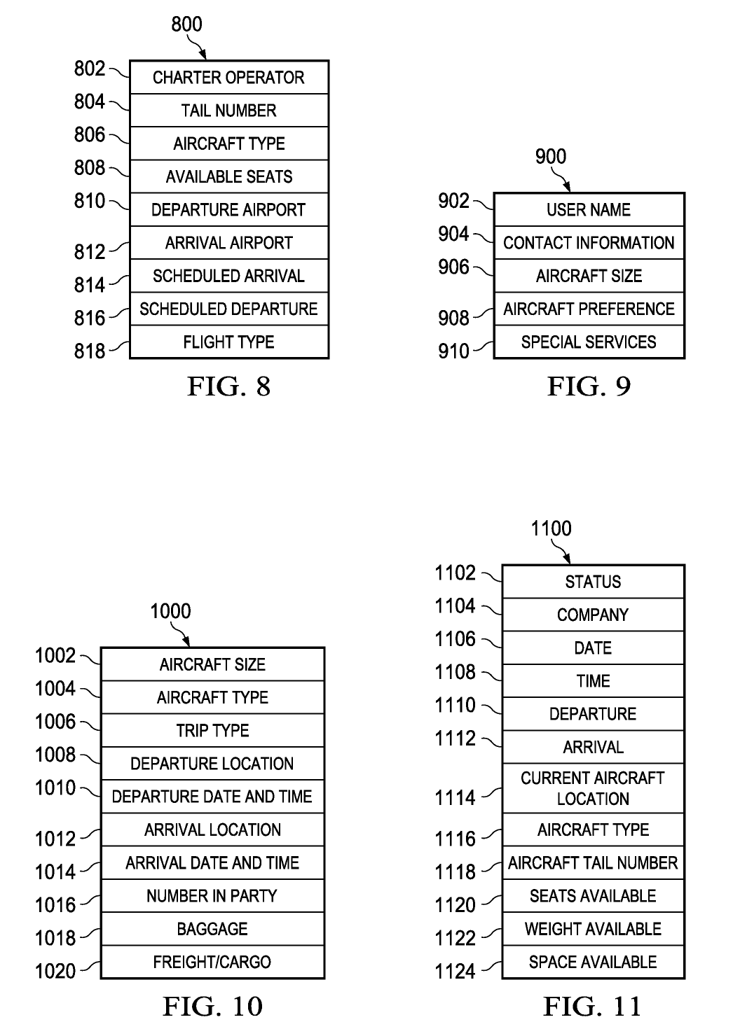

Turning next to FIG. 8, a diagram of a record in a flight database is depicted in accordance with an advantageous embodiment. Record 800 is an example of a record that may be found in flight database 342 and charter flight management environment 300 in FIG. 3. Record 800 is created for different types of flights within flight database 342. These flights include, for example, charter flights, open flights, and planned flights. In this example, record 800 includes charter operator 802, tail number 804, aircraft type 806, available seats 808, departure airport 810, arrival airport 812, scheduled arrival 814, scheduled departure 816, and flight type 818.

Charter operator 802 identifies the charter operator for the flight. Tail number 804 identifies the particular aircraft. The tail number provides a unique identifier for an aircraft. This identifier may be unique for the particular charter operator. The aircraft type identifies the type of aircraft. The aircraft type may be, for example, Gulfstream, Falcon, or Cessna.

Available seats 808 identifies numerous seats that are not taken on the aircraft and that may be available for options, such as ride sharing. If the flight is an open flight, the number of available seats identifies the total number of seats that are present in the aircraft.

Departure airport 810 identifies the airport from which the flight leaves and arrival airport 812 identifies the airport at which the flight arrives for the flight. Scheduled arrival time 814 and scheduled departure time 816 identify times for arrival and departure. Flight type 818 identifies the type of flight in the database. The flight may be, in these examples, an open flight, a charter flight, or a planned flight. An open flight is a flight in which no passengers are scheduled. An open flight may be, for example, a deadhead leg. A charter flight is a flight in which fare paying passengers are present. A planned flight is a flight that may be scheduled upon selection by a user with confirmation by a charter operator in these examples.

Other information may be included in addition to or place of the information identified in reference 800. For example, an identification of special services associated with the flight also may be included. These special services may include, catering, lodging, transportation, and other personal services.

Turning now to FIG. 9, a diagram of record for a user profile is depicted in accordance with an advantageous embodiment. Record 900 is an example of a record that may be found in end user profiles 340 in FIG. 3. In this example, record 900 includes user name 902, contact information 904, aircraft size 906, and aircraft preference 908, and special services 910. User name 902 is the user's login name in these examples. Contact information 904 includes the user's actual name, address, phone number, email, and any other contact information.

Aircraft size 906 identifies the user's preference for a particular size aircraft. An aircraft size may be, for example, full size, super mid size, mid size, light jet, very light jet, personal jet, or turbo prop. Aircraft preference 908 identifies a type of aircraft. The aircraft preference may be, for example, Gulfstream, Falcon, Lear, Cessna, Bombardier, or no preference at all. Special services 910 specifies services that the user may desire, such as catering, lodging, transportation, or other special services.

In FIG. 10, a record illustrating an example of information that may be entered by a user requesting a flight is depicted in accordance with an advantageous embodiment. In this example, record 1000 is an example of a record that may be created by a user through user interface 334 and requesting service through charter service 322 in FIG. 3. Record 1000 includes aircraft size 1002, aircraft type 1004, trip type 1006, departure location 1008, departure date and time 1010, arrival location 1012, arrival date and time 1014, number in party 1016, baggage 1018, and space and cargo 1020.

Aircraft size 1002 identifies the size of the aircraft and aircraft type 1004 identifies the particular type of manufacturer of the aircraft. Trip type 1006 is used to identify the type of trip. A trip type may be, for example, a one way trip, a round trip, or a trip with multiple locations.

Departure location 1008 and departure date and time 1010 identify departure information, while arrival location 1012 and arrival date and time 1014 identify arrival information for a desired flight. Number in party 1016 identifies the number of passengers that are planned for traveling.

Baggage 1018 identifies the baggage that may be carried. This baggage may include, for example, the number of pieces of baggage, as well as the average weight or total weight of the baggage. Freight/cargo 1020 identifies whether freight and cargo is to be carried. Freight/cargo 1020 may include the number of pieces of cargo, as well as the average weight and total weight of the cargo. Additionally, freight/cargo 1020 also may include the amount of space that the cargo takes up. Freight/cargo 1020 may be used for finding a charter flight to carry cargo. The freight and cargo may be carried without passengers or with passengers.

With reference now to FIG. 11, a diagram of a record comprising aircraft information is depicted in accordance with an advantageous embodiment. Record 1100 is an example of a record that may be stored in flight database 342 in FIG. 3 for use in generating potential flight choices. Record 1100 contains information about an aircraft that may be scheduled for a flight using charter flight management environment 300 in FIG. 3. Record 1100 includes status 1102, company 1104, date 1106, time 1108, departure 1110, arrival 1112, current aircraft location 1114, aircraft type 1116, aircraft tail number 1118, seats available 1120, weight available 1122, and space available 1124.

Status 1102 identifies the status of the aircraft. The aircraft may be, for example, available, in flight, chartered, or in maintenance. Company 1104 identifies the charter operator for the aircraft. Date 1106 and time 1108 identify arrival and departure times for any current flights that may be chartered for the aircraft. Departure 1110 identifies the departure location for the aircraft, and arrival 1112 identifies the arrival location for the aircraft. Current aircraft location 1114 identifies the current location of the aircraft. This aircraft may be located on the ground, at a particular airport, or the aircraft may be in flight. If the aircraft is in flight, the current aircraft location identifies the location of the aircraft in its route.

Aircraft type 1116 identifies the manufacturer of the aircraft in these examples. Aircraft tail number 1118 is a unique identifier for identifying a particular aircraft. Seats available 1120 identifies seats that may be available on the aircraft or the total number of seats present in the aircraft. Weight available 1122 identifies the amount of weight that the aircraft can carry or the amount of the remaining weight that the aircraft can carry. Space available 1124 may identify the amount of space available for cargo.

The different records illustrated in FIGS. 8-11 are presented for purposes of depicting one manner in which information may be stored. Of course, other fields may be used in addition to or in place of fields in the particular examples. The particular information and arrangement of fields in each type of record will vary depending on the particular implementation.

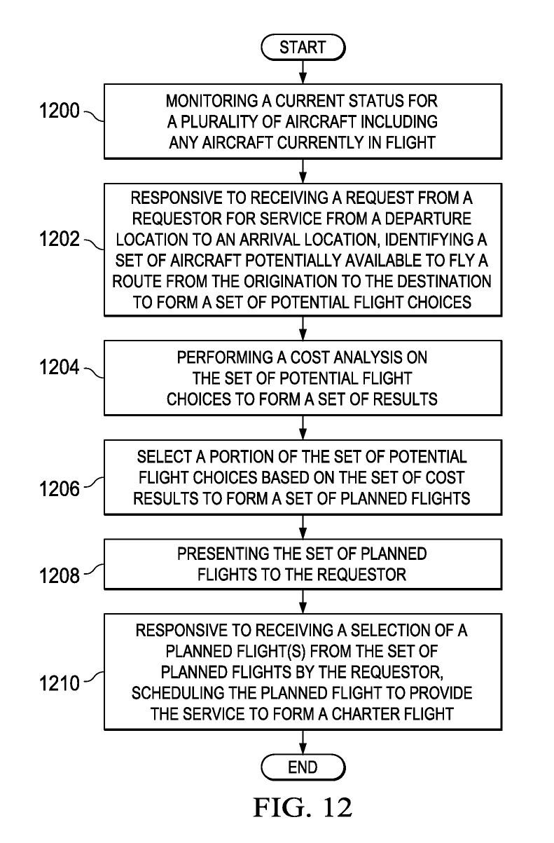

Turning now to FIG. 12, a high level flowchart of a process for managing charter flights is depicted in accordance with an advantageous embodiment. The process illustrated in FIG. 12 may be implemented in charter flight management environment 300 in FIG. 3. In particular, the different processes illustrated in FIG. 12 may be implemented in service components 304 in FIG. 3.

The process begins by monitoring the current status for a plurality of aircraft, including any aircraft currently in flight (operation 1200). In operation 1200, information may be received from various charter operators through a scheduler interface. Additionally, information about aircraft currently in flight may be received through aircraft situation display feeds.

In response to receiving a request from a requester for service from a departure location to an arrival location, a set of aircraft potentially available to fly a route from the origination to the destination is identified to form a set of potential flight choices. The request may be received from end user subscribers 302 through user interface 334 in FIG. 3.

The process then performs a cost analysis of the set of potential flight choices to form a set of results (operation 1204). The process selects a portion of the set of potential flight choices based on a set of cost results to form a set of planned flights (operation 1206). The set of planned flights are then presented to the requester (operation 1208). These planned flights are presented through user interface 334 in FIG. 3 in these examples.

In response to receiving a selection of a planned flight from a set of planned flights by the requester, the planned flight is scheduled to provide service to form a charter flight (operation 1210) with the process terminating thereafter. In operation 1210, the charter operator may be notified that the user has selected a particular planned flight. The charter operator may then confirm that flight to form a charter flight. This confirmation may include, for example, an exchanging or arrangement for payment between the requester and the charter operator. This arrangement for payment in the example does not involve service components 304 in FIG. 3.

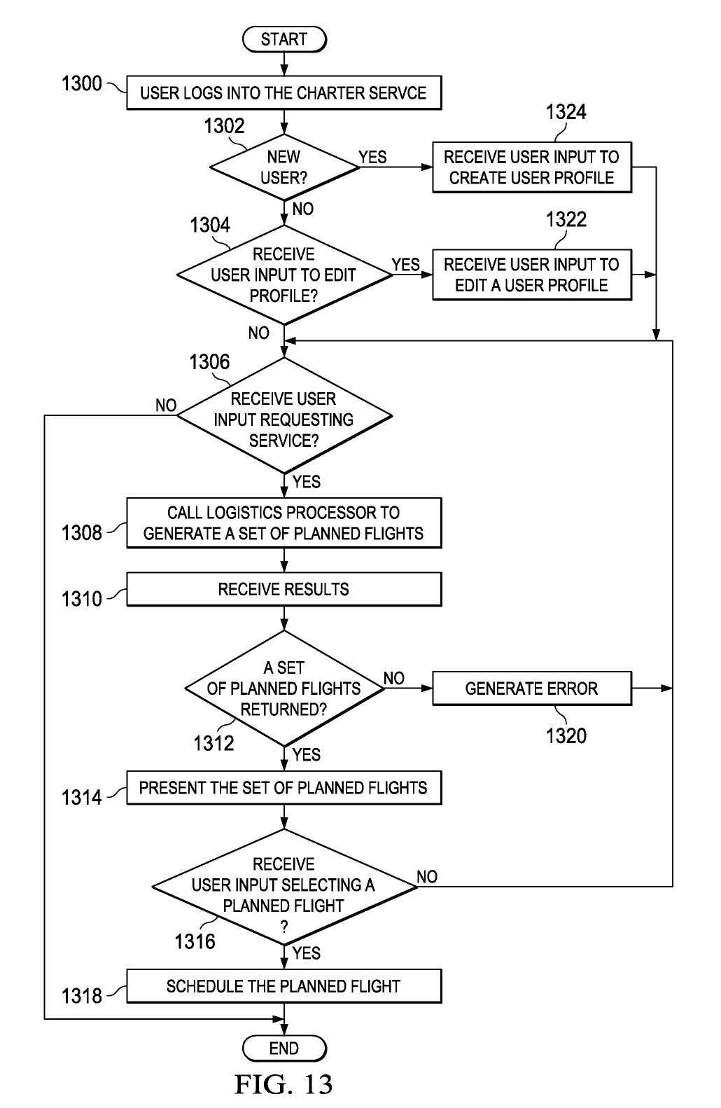

Turning now to FIG. 13, a flowchart of a process for requesting a flight is depicted in accordance with an advantageous embodiment. The process illustrated in FIG. 13 may be implemented in a software component, such as charter service 322 in FIG. 3. In particular, the information may be exchanged between charter service 322 and requesters or users through user interface 334 in FIG. 3.

The process begins with a user logging into the charter service (operation 1300). Thereafter, a determination is made as to whether the user is a new user (operation 1302). If the user is not a new user, a determination is made as to whether the user has decided to edit a user profile for the user (operation 1304).

If the user has decided not to edit the user profile, a determination is made as to whether the user input has been received requesting service (operation 1306). If the user has entered user input requesting service, the process calls a logistics processor to generate a set of planned flights (operation 1308). In this example, the user input in operation 1306 may include information about a flight that the user wishes to charter. In operation 1308, the call to the logistics processor includes this information. The process then receives results from the logistics processor (operation 1310).

Thereafter, a determination is made as to whether a set of planned flight is returned in the results (operation 1312). If a set of planned flights is returned, then a set of planned flights are presented to the user (operation 1314). A determination is then made as to whether the user input has been received selecting a planned flight (operation 1316). If the user input has been received selecting the planned flight, the process then schedules the planned flight (operation 1318) with the process terminating thereafter. In operation 1318, a number of steps may occur involving notifying the charter operating and receiving confirmation for the flight.

With reference again to operation 1316, if the user has not selected a planned flight from the set of planned flights, the processor returns to operation 1306 as described above. In this case, the user may not have found any flights that the user wanted to charter. As a result, the user may then re-request service with different preferences. In operation 1306, if the user input does not request service, then the process terminates.

With reference again to operation 1312, if the results received do not include a set of planned flights then the results indicate that no flights meet the user's request. The process then generates an error (operation 1320) and returns to operation 1306 as described above. The error in these examples is an error message presented to the user indicating that no flights have been returned meeting the request.

With reference again to operation 1304, if the user has decided to edit the properties, the process receives user input to modify the user profile (operation 1322) with the process proceeding to operation 1306 as described above. In this instance, the user may desire to change certain preferences or contact information. Referring back to operation 1302, if the user is a new user, the process receives user input to create a user profile (operation 1324) with the process then proceeding to operation 1306 as described above. With reference again to operation 1306, if the user does not request service, the process terminates.

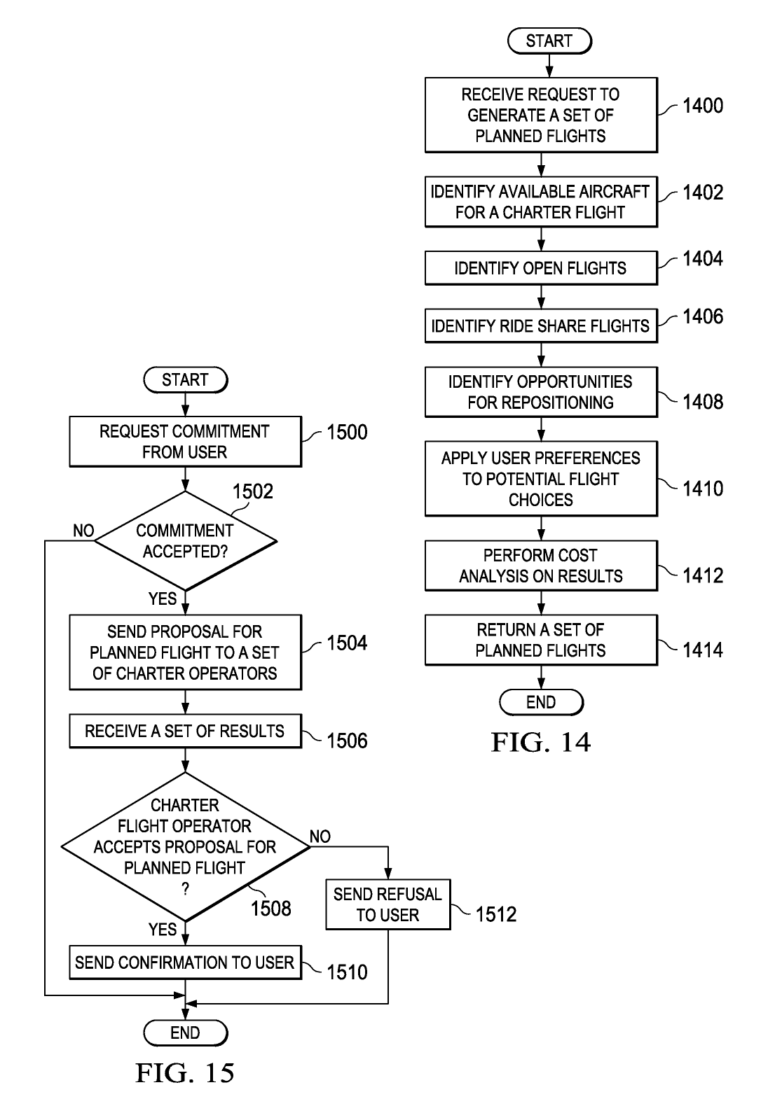

With reference now to FIG. 14, a flowchart of a process for identifying potential flight choices to generate a set of planned flights is depicted in accordance with an advantageous embodiment. The process illustrated in FIG. 14 may be implemented in charter flight management environment 300 in FIG. 3. In particular, this process may be implemented in logistics processor 336 in FIG. 3.

The process begins by receiving a request to generate a set of planned flights (operation 1400). In these examples, a request is received by logistics processor 336 from charter service 322 in FIG. 3. The process identifies available aircraft for a charter flight (operation 1402). This identification may be made using information in flight database 342 in FIG. 3.

Aircraft that are available may be identified by locating aircraft present in the departure and arrival airports at the date and times or within a window of the date and times as requested by the requester.

Additionally, the available aircraft may be identified based on the distance that a user is willing to travel from the arrival and destination locations. Other information that may be taken into account in identifying available aircraft includes, for example, potential re-positioning of the aircraft from one location to another location. The process then identifies any open flights that are present (operation 1404).

The process also identifies ride share flights that may be available (operation 1406). Ride share flights are charter flights that have seats available in which users of those flights are agreeable to sharing those seats with other users. The process also identifies opportunities for re-positioning (operation 1408). In identifying aircraft that may be re-positioned from one location to another location to schedule a flight, the process may include buffers or thresholds.

For example, re-positioning may be performed, but only for aircraft within a certain distance or location of the departure and arrival locations based on the dates and windows identified by a user. The process then applies user preferences to the potential flight choices (operation 1410). In operation 1410, user preferences may be used to eliminate potential flight choices or provide an order in which potential flight choices are to be presented as planned flights.

The process then performs a cost analysis on results (operation 1412). The cost analysis includes, for example, determining whether the cost for re-positioning aircraft out weighs the benefit of obtaining the additional fare. Also, the cost analysis may include other factors, such as maintenance factors. For example, if a planned flight causes maintenance to be required at a time when the charter operator must have the aircraft for some other flight or operation, then the benefit does not out weigh the cost.

Further, in forming the cost analysis, certain airlines may require a certain amount of profitability before scheduling a charter flight. As a result, one charter operator may accept one flight while another charter operator may refuse the same flight under the same conditions based on different levels of profitability desired by the charter operators.

The process then returns a set of planned flights (operation 1414) with the process terminating thereafter. These set of planned flights is a result returned to charter service 322 for presentation to a user.

With reference now to FIG. 15, a flowchart of a process for scheduling a selected planned flight is depicted in accordance with an advantageous embodiment. The process illustrated in FIG. 15 is a more detailed example of operation 1318 in FIG. 13.

The process begins by requesting a commitment from the user for the selected planned flight (operation 1500). A determination is then made as to whether the user has accepted the request for the commitment (operation 1502). If the user has accepted the request for commitment, then the process sends a proposal for the planned flight to a set of one or more charter operators (operation 1504). In operation 1504, charter service 322 in FIG. 3 may send the proposal to a set of charter operators, such as charter operator 314 through scheduler interface 324 in FIG. 3.

The process then receives a set of results from a charter operator (operation 1506). A determination is made as to whether the charter operator accepts the proposal for the planned flight (operation 1508).

If the charter operator accepts the proposal, then a confirmation is sent to the user (operation 1510) with the process terminating thereafter. At this point, the user and charter operator may make arrangements for any changes in the status of a planned flight to a charter flight that may be received by charter service 334 in FIG. 3 through scheduler interface 324 in FIG. 3 from charter operation 314 in FIG. 3 after the payment and arrangements have been made between the user and charter operator 314 in FIG. 3.

With reference again to operation 1508, if the charter operator does not accept the proposal, then the process sends the refusal to the user (operation 1512) with the process terminating thereafter. At this point, the user may reinitiate the process in FIG. 13 to select another flight. With reference again to operation 1502, if the user does not accept the request for commitment, the process terminates.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of computer usable or readable program code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

Thus, the different advantageous embodiments provide a computer implemented method, apparatus, and computer program code for managing charter flights. In the different advantageous embodiments, a current status for aircraft is monitored including any aircraft in flight. In response to receiving a request from a requester for service, a set of aircraft potentially available to fly a route from the departure location to the arrival location is identified to perform a set of potential flight choices. A cost analysis is performed on the set of potential flight choices to form a set of cost results. A portion of the set of potential flight choices is selected based on the set of cost results to form a set of planned flights. These planned flights are then presented to the requester.

The requester may select from the presented planned flights. Upon selection of a flight, a confirmation is obtained from the charter operator in these examples. In other examples, confirmations may be unnecessary depending on the arrangements between the charter operator and the service. As a result, the different advantageous embodiments are able to manage flights for charter operators by identifying potential flights that may be generated based on user inputs. In the different advantageous embodiments, the monitoring of flights and aircrafts are for a number of different charter operators. As a result, the offering of flights may be considerably greater then what is currently available when users contact individual charter operators.

Further, the use of information about the actual aircraft positions in real time also provides an ability to more accurately identify the locations of aircraft and provide higher utilization of aircraft for both customers and charter operators. The environment provided by the different advantageous embodiments allow for an aggregation of charter operators in offering or identifying planned flights to offer to users. In this manner, increased options and flexibility is present for customers wanting to charter flights. Also, by allowing for an ability to increase utilization of charter aircraft, charter operators are able to offer lower prices, encourage more use of charter flights.

Further, the different advantageous embodiments aid charter operators and their aircraft in the air rather than on the ground. Additionally, the different embodiments may help put customers on what otherwise would be empty legs as well as increase load factors. In other words, in addition to reducing empty legs, the different advantageous embodiments also help fill up more seats on a given leg, through the shared bringing together of single-seat on-demand customers contrasted to one or a few customers renting an entire plane with numerous empty seats.

Still further, the different identifications of aircraft to generate planned flights and cost analysis include considering multiple charter operators resulting in more options for users. By the ability to use contract pilots more planned flight options may be made available because of asset availability. These and other features, benefits, and/or advantages may be found in one or more of the advantageous embodiments.

The different advantageous embodiments can take the form of an entirely hardware embodiment, an entirely software embodiment, or an embodiment containing both hardware and software elements. Some embodiments are implemented in software, which includes but is not limited to forms, such as, for example, firmware, resident software, and microcode.

Furthermore, the different embodiments can take the form of a computer program product accessible from a computer-usable or computer-readable medium providing program code for use by or in connection with a computer or any device or system that executes instructions. For the purposes of this disclosure, a computer-usable or computer readable medium can generally be any tangible apparatus that can contain, store, communicate, propagate, or transport the program for use by or in connection with the instruction execution system, apparatus, or device.

The computer usable or computer readable medium can be, for example, without limitation an electronic, magnetic, optical, electromagnetic, infrared, or semiconductor system, or a propagation medium. Non limiting examples of a computer-readable medium include a semiconductor or solid state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-R/W) and DVD.

Further, a computer-usable or computer-readable medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example without limitation, physical or wireless.

A data processing system suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories which provide temporary storage of at least some computer readable or computer usable program code to reduce the number of times code may be retrieved from bulk storage during execution of the code.

Input/output or I/O devices can be coupled to the system either directly or through intervening I/O controllers. These devices may include, for example, without limitation to keyboards, touch screen displays, and pointing devices. Different communications adapters may also be coupled to the system to enable the data processing system to become coupled to other data processing systems or remote printers or storage devices through intervening private or public networks. Non-limiting examples are modems and network adapters are just a few of the currently available types of communications adapters.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer implemented method for managing charter flights, the computer implemented method comprising:
monitoring a current status for a plurality of aircraft including any aircraft currently in-flight;
responsive to receiving a request from a requester for service from a departure location to a arrival location, identifying a set of flights from the departure location to the arrival location using the current status of the plurality of aircraft from multiple charter operators to form a set of potential flight choices;
performing a cost analysis on the set of potential flight choices to form a set of cost results;
selecting a portion of the set of potential flight choices based on the set of cost results to form a set of planned flights; and
presenting the set of planned flights to the requester.

2. The computer implemented method of claim 1 further comprising:
responsive to receiving a selection of a planned flight from the set of planned flights by the requester, scheduling the planned flight to provide the service to form a charter flight.

3. The computer implemented method of claim 2, wherein the scheduling step comprises:
billing the requester for offered flight;
responsive to receiving payment for the planned flight, scheduling the planned flight to form the charter flight.

4. The computer implemented method of claim 1, wherein the selecting step comprises:
comparing the set of cost results to a policy to form a comparison; and
selecting the portion of the potential flight sources based on the comparison.

5. The computer implemented method of claim 1, wherein the performing step comprises:
performing a cost and benefit analysis for each potential flight choice in the set of potential flight choices to form a cost result for the set of cost results.

6. The computer implemented method of claim 1, wherein the selecting step further comprises:
selecting a portion of the set of potential flight choices based on the set of cost results and on a set of user preferences of a requester of the service.

7. An apparatus comprising:
a request system capable of receiving flight requests;
a flight tracking system capable of real time monitoring of a status for a plurality of aircraft for multiple charter operators;
a route generator capable of generating a set of new routes for portion of the plurality of aircraft based on current aircraft status and a set of received flight requests to form a set of generated routes; and
a cost analysis system capable of determining a cost and benefit for each of the set of generate routes.

8. The apparatus of claim 7, wherein the flight tracking system is capable of monitoring a status of in-flight aircraft.

9. The apparatus of claim 7, wherein the cost analysis unit is capable of determining the cost status for each of the set of generated routes based on at least one of fuel cost, revenue, and weather.

10. The apparatus of claim 7, wherein the route generator is capable of generating a next route for an aircraft in the plurality of aircraft that is currently in-flight.

11. The apparatus of claim 7 further comprising:
a passenger and user profile system capable of storing a user profile of preferences, wherein the route generator generates the set of new routes for the portion of the plurality of aircraft based on current aircraft status, a set of received flight requests, and the user profile to form a set of generated routes.

12. The apparatus of claim 7 further comprising:
a charter flight supplier services system capable of receiving information about a plurality of aircraft from a the multiple charter operators, associating each of the set of aircraft with a charter operator in the multiple charter operators, and providing the set of generated routes and a set of associated costs and benefit status for the aircraft associated with the charter operator to the charter operator.

13. The apparatus of claim 7, wherein the route generator is capable of generating a new route from an empty leg.

14. The apparatus of claim 7 further comprising:
a scheduler interface capable of receiving status information for the plurality of aircraft from a plurality of charter operators.

15. A computer program product for managing charter flights, the computer program product comprising:
computer recordable media;
program code, stored on the computer recordable media, for monitoring a current status for a plurality of aircraft from multiple charter operators including any aircraft currently in-flight;
program code, stored on the computer recordable media, responsive to receiving a request from a requester for service from a departure location to a arrival location, for identifying a set of flights from the departure location to the arrival location using the current status of the plurality of aircraft to form a set of potential flight choices;
program code, stored on the computer recordable media, for performing a cost analysis on the set of potential flight choices to form a set of cost results;
program code, stored on the computer recordable media, for selecting a portion of the set of potential flight choices based on the set of cost results to form a set of planned flights; and
program code, stored on the computer recordable media, for presenting the set of planned flights to the requester.

16. The computer program product of claim 15 further comprising:
program code, stored on the computer recordable media, responsive to receiving a selection of a planned flight from the set of planned flights by the requester, for scheduling the planned flight to provide the service to form a charter flight.

17. The computer program product of claim 16, wherein the program code, responsive to receiving a selection of a planned flight from the set of planned flights by the requester, for scheduling the planned flight to provide the service to form a charter flight comprises:
program code, stored on the computer recordable media, for obtaining billing the requester for offered flight;
program code, stored on the computer recordable media, responsive to receiving payment for the planned flight, for scheduling the planned flight to form the charter flight.

18. The computer program product of claim 15, wherein the program code for selecting a portion of the set of potential flight choices based on the set of cost results to form a set of planned flights comprises:
program code, stored on the computer recordable media, for comparing the set of cost results to a policy to form a comparison; and
program code, stored on the computer recordable media, for selecting the portion of the potential flight sources based on the comparison.

19. The computer program product of claim 15, wherein the program code for performing a cost analysis on the set of potential flight choices to form a set cost results comprises:
program code, stored on the computer recordable media, for performing a cost and benefit analysis for each potential flight choice in the set of potential flight choices to form a cost result for the set of cost results.

20. The computer program product of claim 15, wherein the program code for selecting a portion of the set of potential flight choices based on the set of cost results to form a set of planned flights further comprises:
program code, stored on the computer recordable media, for selecting a portion of the set of potential flight choices based on the set of cost results and on a set of user preferences of a requester of the service.
